(19) United States
(12) Patent Application Publication
(10) Pub. No.: US 2010/0132219 A1
(43) Pub. Date: Jun. 3, 2010

(54) DRYER WITH REVERSE TUMBLE ACTION

(76) Inventors: Soheil Etemad, Prospect, KY (US); Arnold R. Estravillo, Mt. Washington, KY (US); Joseph Hardy Frazar, Louisville, KY (US)

Correspondence Address: MERCHANT & GOULD GE CONSUMER & INDUSTRIAL, P.O. BOX 2903, MINNEAPOLIS, MN, 55402, US

(21) Appl. No.: 12/325,221

(22) Filed: Nov. 30, 2008

(51) Int. Cl. F26B 3/02; D06F 58/04; F26B 21/08

(52) U.S. Cl. 34/499; 34/108; 34/557

(57) ABSTRACT

Systems and methods for improving drying efficiency are disclosed. The systems may include a dryer a motor operatively connected to the drum and configured to cause the drum to rotate. The systems further include a controller for controlling operation of the dryer and configured to alter a drum rotation direction during a drying cycle. The methods may include, at the beginning of the drying cycle, causing the drum to rotate in a first rotation direction thereby causing the contents of the dryer to traverse along the drum centerline. In addition, causing the contents of the dryer to traverse along the drum centerline comprises reversing the rotation direction during the drying cycle. Reversing the rotation direction promotes movement of the contents within the drum in the opposite direction.

### CROSS-REFERENCE TO RELATED APPLICATIONS

The present application is related to U.S. patent application having Ser. No. 11/853,271 titled “Centrifugal Switch Bypass for Reverse Tumble Dryers” filed Sep. 11, 2007 and U.S. patent application having Ser. No. 12/325,219 titled “Dryer With Stationary Drying Cycle” filed Nov. 30, 2008, both of which are hereby incorporated by reference in their entirety.

### FIELD OF INVENTION

Embodiments of the present invention relate to appliances. More specifically, embodiments of the present invention relate to clothes dryers having a reverse tumbling action.

### BACKGROUND OF THE INVENTION

With conventional domestic clothes dryers, it is not uncommon to have some damp items in a load of laundry at the end of a drying cycle, especially for large loads of laundry. In addition, there is a tendency for laundry to become tangled during the drying cycle. As a result, a few items within the load of laundry may be overly dried (i.e. expose dot excessive heating) and other items may remain damp and/or wet at the end of the drying cycle. Furthermore, currently dryers utilize a unidirectional motor which cannot be reversed.

There exists a need for a dryer having a drying cycle that can improve dying effectiveness. Furthermore, there exists a need for a dryer having a drying cycle that can reduce tangling of laundry during the drying cycle.

### BRIEF DESCRIPTION OF THE INVENTION

Consistent with embodiments of the present invention, systems for improving drying efficiency are disclosed. The systems include a dryer comprising a drum having a drying compartment, and a motor configured to cause the drum to rotate. The systems further include a controller for controlling operation of the dryer and operatively connected to the motor and configured to alter the rotational direction of the drum during a drying cycle.

Still consistent with embodiments of the present invention, methods for improving drying efficiency are disclosed. The dryer comprises a controller operatively connected to motor operatively connected to a drum, including a baffle, in order to facilitate drum rotation. The methods comprise receiving, at the controller, an indication to start a drying cycle. At the beginning of the drying cycle the drum rotates in a first direction. The methods further include causing the contents of the dryer to traverse in a generally axial direction, that is, a direction generally parallel to the drum centerline during drum rotation. Causing the contents of the dryer to traverse in an axial direction is facilitated by configuring the baffle such that during drum rotation the baffle promotes movement of the contents within the drum in the axial direction. In addition, the drum and baffle are configured to allow the contents of the dryer to traverse axially in one direction when the drum rotates in a first rotational direction and to allow the contents of the dryer to traverse axially in the opposite direction when the drum rotates in a second rotational direction such as when the rotational direction is reversed during the drying cycle. By this arrangement reversing the rotation direction of the drum promotes movement of the contents within the drum in the opposite axial direction.

### BRIEF DESCRIPTION OF THE FIGURES

Non-limiting and non-exhaustive embodiments are described with reference to the following figures, wherein like reference numerals refer to like parts throughout the various views unless otherwise specified.

FIG. 1 depicts basic dryer components;

FIG. 2 depicts a drive assembly for a dryer having reverse tumbling action consistent with embodiments of the invention; and

FIG. 3 depicts an interior of a dryer drum consistent with embodiments of the invention.

### GENERAL DESCRIPTION

Reference may be made throughout this specification to “one embodiment,” “an embodiment,” “embodiments,” “an aspect,” or “aspects” meaning that a particular described feature, structure, or characteristic may be included in at least one embodiment of the present invention. Thus, usage of such phrases may refer to more than just one embodiment or aspect. In addition, the described features, structures, or characteristics may be combined in any suitable manner in one or more embodiments or aspects. Furthermore, reference to a single item may mean a single item or a plurality of items, just as reference to a plurality of items may mean a single item. Moreover, use of the term “and” when incorporated into a list is intended to imply that all the elements of the list, a single item of the list, or any combination of items in the list has been contemplated. Also note the terms “dying efficiency” and “drying effectiveness” may be used interchangeably throughout this specification.

Embodiments of the present invention utilize at least one baffle located within a drum in conjunction with altering the drum's rotational direction to improve drying effectiveness. The drum rotation may be altered by changing the rotation speed and reversing the rotation direction of the drum throughout the drying cycle. The baffle within the drum is configured and positioned to improve drying efficiency by promoting movement of the contents within the drum such that the contents do not remain in a single location throughout the drying cycle.

### DETAILED DESCRIPTION

Various embodiments are described more fully below with reference to the accompanying drawings, which form a part hereof, and which show specific embodiments of the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Accordingly, the following detailed description is, therefore, not to be taken in a limiting sense.

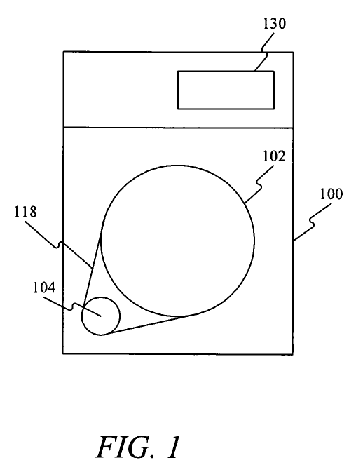

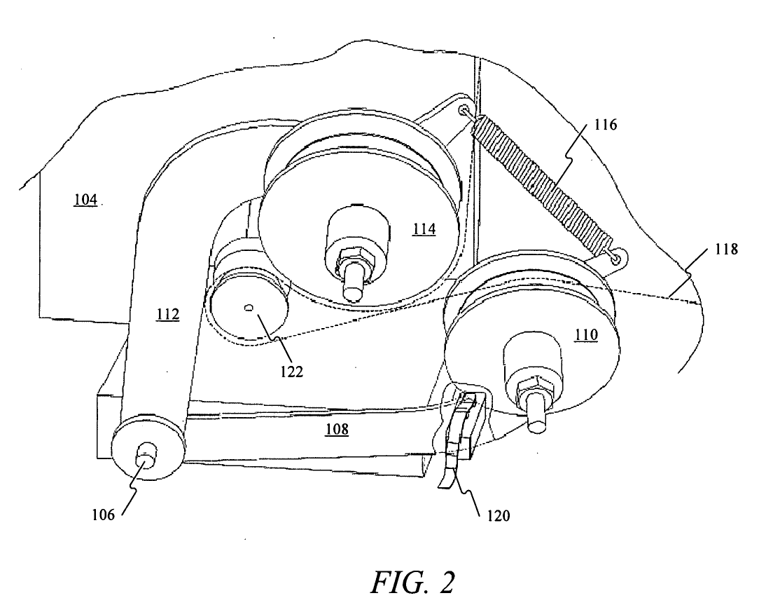

Referring now to the figures, FIG. 1 depicts a section of a dryer 100 showing a motor 104 used to rotate a drum 102. Motor 104 is operatively connected to drum 102 via a belt 118. Referring now to FIG. 2, during operation of the motor 104 idler arms 108 and 112 in conjunction with idler pulleys 110 and 114 maintain tension on a belt 118 (shown in FIG. 1). When the direction and speed of the motor is changed, thereby reversing the drum rotation and altering its rotational speed, idler arms 108 and 112 may pivot about a pivot point 106. In addition, to help maintain a constant tension on belt 118, a spring 116 or other connecting mechanisms may be used to connect idler arm 108 to idler arm 112. For example, spring 116 may be replaced with a turnbuckle, a bolt, and an elastic band to create a constant tension or variable tension on belt 118.

Dryer 100 may also include a belt switch 120. Belt switch 120 may be configured such that depressing belt switch 120 causes the drying cycle to terminate. Should belt switch 120 be depressed, motor 104 may stop rotating, a heating element (not shown) may shut down, and an alarm may sound. It is contemplated that other functions to alert a user of possible malfunctions or terminate dryer operations may occur when belt switch 120 is depressed. For example, in the event belt 118 breaks or separates from a pulley 122 attached to motor 104 or drum 102, idler arm 112 may depress belt switch 120 causing the drying cycle to terminate and an audible alarm to sound.

In other aspects of the invention, idler arms 108 and 112 may be replaced with a stretch belt. When utilizing the stretch belt, idler arms may not be needed to maintain tension on belt 118. However, idler arm 112 may continue to be utilized as a safety for depressing a belt switch 120.

Still consistent with embodiments of the invention, moisture sensors 208 and 210 may be used to reverse dryer 100's rotation direction. For example, if moisture sensor 210, located near S-Baffle 202 or some other feature within drum 102, indicates a constant moisture level for a preset amount of time, moisture sensor 210 may initiate controller 130 to reverse the rotation direction. For instance, during the drying cycle, a wet sock may come to rest against moisture sensor 210 and S-Baffle 202 due to drum rotation or other factors. Moisture sensor 210 may then send an indication to controller 130 indicating the constant moisture level. In an attempt to dislodge the wet sock, controller 130 may then cause drum 102 to reverse rotation direction.

Various aspects of the invention may also include the rotation of drum 102 being altered at various times throughout the drying cycle. For instance, the drum rotation and drum speed may be altered by controller 130 at multiple times throughout the drying cycle. Controller 130 may have one or more preset routines which indicate that drum 102 may spin in a clockwise direction for a preset amount of time and reverse and rotate in a counter-clockwise direction for a preset period of time. For example, at the beginning of the drying cycle, the drum may rotate in a counter-clockwise direction for nine minutes and then rotate in the clockwise direction for five minutes during the drying cycle. After rotating in the clockwise direction for five minutes drum 102 may reverse directions again and rotate in the counter-clockwise direction for nine minutes.

To reverse the rotational direction of the drum, the controller may shut down the dryer motor. The dry motor may be a reversible motor. Once the drum has stopped, the polarity on the motor is reversed to cause the motor (i.e. the drum) to reverse rotation direction. During drum reversal, an optocoupler may be used to power a relay hold up circuit. Before the drum begins to slow down in order to change rotational direction, a bypass relay may bypass a centrifugal switch thereby keeping the heating element activated while the drum reverses its rotational direction.

In it contemplated that the time intervals between rotation and counter-rotation are not necessarily fixed. For example, drum 102 may rotate counter-clockwise for nine minutes, clockwise for two minutes, counter-clockwise for three minutes, clockwise for six minutes, etc. The possible combinations of drum rotation in the clockwise and counter-clockwise directions are virtually limitless.

In various aspects of the invention, controller 130 may also alter the rotation speed of drum 102 according to preset drying modes. For instance, while washing delicates the drum may rotate at one speed and for drying towels or other bathroom items drum 102 may rotate at a different speed. For example, while drying delicates dryer 100 may rotate at 30 RPM. When drying more rugged items such as bath towels or athletic gear, the drum may rotate at 20 RPM.

Furthermore, aspects of the invention may also include controller 130 altering the rotation speed of drum 102 during the drying cycle. For instance, at the beginning of the drying cycle, drum 102 may spin at a beginning speed. As the drying cycle progresses, drum 102's rotation speed may increase and decrease. For example, at the beginning of the drying cycle, drum 102 may rotate at 60 RPM. At a second drying cycle stage, the rotation speed may increase to 90 RPM. At a third drying cycle stage, the rotation speed may decrease to 30 RPM.

Still consistent with embodiments of the invention, drum 102's rotation speed may increase and decrease in a linear fashion. For example, at the beginning of the drying cycle, drum 102 may rotate at 60 RPM and the rotation speed may decrease and increase in a constant manner throughout the drying cycle.

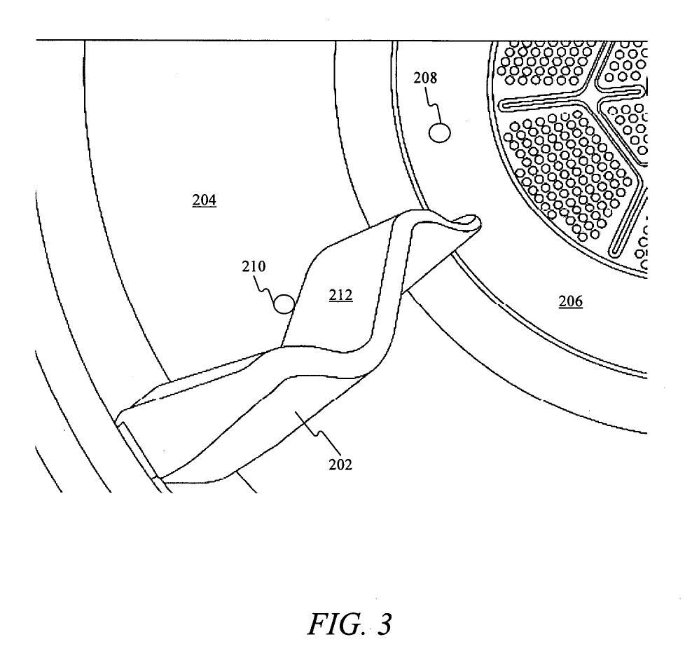

Referring now to FIG. 3, FIG. 3 depicts the interior of drum 102. Drum 102 may have a drum sidewall 204 and a drum end wall 206. Connected to drum sidewall 204 may be an S-Baffle 202. In addition, connected to drum sidewall 204 and drum end wall 206 may be moisture sensors 210 and 208.

During rotation of drum 102, S-Baffle 202 promotes movement of laundry along the drum center line. S-Baffle 202 promotes movement along the drum center line via S-Baffle 202's shape and placement within drum 102. For instance, a plane 212 on S-Baffle 202 may be slanted such that when laundry impacts plane 212 the laundry is deflected toward the front of dryer 100. For example, a plane 212 on S-Baffle 202 may propel the laundry toward the front of drum 102 during clockwise rotation. When drum 102's rotation direction is reversed, plane 212 may promote movement of the laundry toward the rear of drum 102.

Moisture sensors 208 and 210 may be operatively connected to a controller (not shown). When moisture sensors 208 and 210 indicate a moisture level above a maximum moisture level, controller 130 may substantially prohibit termination of the drying cycle. Substantially preventing termination of the drying cycle means lengthening the drying cycle by a maximum preset amount of time, selected to avoid damage to the load that could result from prolonged exposure to heat.

In various aspects of the invention, depending on the type of items being dried, moisture sensors 208 and 210 may extend the drying cycle for 30 minutes, one hour, etc. For example, while drying bath towels, if moisture sensors 208 and 210 indicate moisture level above the maximum moisture level, the drying cycle may be extended for 30 minutes or one hour, but no longer than 1.5 hours. If drying delicate linens and moisture sensors 208 and 210 indicate moisture level above the maximum moisture level, the drying cycle may be extended for 15 minutes or 30 minutes, but no longer than 45 minutes.

Consistent with embodiments of the present invention, moisture sensors 208 and 210 may also terminate the drying cycle prematurely. If moisture sensors 208 and 210 indicate moisture levels below a minimum moisture level, controller 130 may terminate the drying cycle. For example, if delicate linens are being dried for a preset time of 45 minutes and moisture sensors 208 and 210 detect moisture levels below the minimum moisture level after 30 minutes, the drying cycle may then be terminated to save energy and prevent unnecessarily exposing the linens to excessive heat and mechanical abuse from the tumbling action of dryer 100.

Furthermore, various aspects of the invention may include altering both the rotation direction and the rotation speed during the drying cycle. For instance, during the drying cycle drum 102 may rotate clockwise at a first rotation speed and then may rotate counter-clockwise at a second rotation speed. Additionally, variations in rotation speed may occur during a single direction of rotation. For example, during the drying cycle drum 102 may begin rotating clockwise at a first rotation speed. During clockwise rotation, controller 130 may change drum 102's rotation speed to a second rotation speed. Later during the drying cycle, controller 130 may cause drum 102 to rotate counter clockwise at a third rotation speed.

S-Baffle 202 has the general S-shape depicted in FIG. 2, to enhance the tumbling of the clothes in the drum as the drum rotates. More specifically, the general S shape tends to impart the desired generally axial direction to the movement of the clothes load as the items tumble. With this shape, when the drum rotates in a first direction the clothes tend to move axially in a first direction as they tumble, and to move axially in the opposite direction when the direction of rotation is reversed. More specifically for the embodiment of FIG. 2, when the drum rotates in a clockwise direction, the clothes tend to move toward the front of the drum as they tumble, and when the drum rotates in the counterclockwise direction, the clothes tend to move toward the rear of the drum as they tumble. Other shapes that achieve such motion may be similarly employed. In addition, S-Baffle 202 may also have a radial length that differs from other baffles located in drum 102. For instance, S-Baffle 202 may protrude inward toward the center of drum 102 further than other baffles within the drum. For example, S-Baffle 202 may be located within drum 102 with standard baffles found in dryers and S-Baffle 202 may be anywhere from an eighth of an inch to an inch to two inches longer than the standard baffle. This extended length enhances the imparting of the axial movement of the clothes during tumbling.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A dryer comprising:
a drum having a drying compartment;
a motor operatively connected to the drum and configured to cause the drum to rotate; and
a controller for controlling operation of the dryer and operatively connected to the motor and configured to cause the drum to reverse the drum rotation direction.

2. The dryer of claim 1, wherein altering the drum rotation direction further comprises the controller being configured to cause the drum to periodically reverse the drum rotation direction during the drying cycle.

3. The dryer of claim 1, wherein altering the drum rotation direction further comprises the controller being configured to cause the drum to change rotation speed.

4. The dryer of claim 1, wherein the motor is a reversible motor and the controller is configured to alter the rotation direction by reversing the motor.

5. The dryer of claim 1, wherein the controller is configured to alter the drum rotation direction according to at least one preset drying cycle.

6. The dryer of claim 1, wherein the motor is operatively connected to the drum via a belt, the dryer further comprising a first idler arm including a first idler pulley configured to substantially maintain the tension on the belt during the rotation direction being reversed.

7. The dryer of claim 6, further comprising a belt switch configured to terminate the drying cycle, wherein the first idler arm is configured to depress the belt switch in the event the belt breaks.

8. The dryer of claim 1, wherein altering the drum rotation direction during the drying cycle comprises the controller being configured to reverse the drum rotation direction a plurality of times during the drying cycle.

9. The dryer of claim 1, wherein the motor is operatively connected to the drum via a belt, the dryer further comprising:
a first idler arm including a first idler pulley and a second idler arm including a second idler pulley;
a tensioning member connecting the first idler arm and the second idler arm, the tensioning member configured to substantially maintain the tension on the belt during the rotation direction being reversed; and
a belt switch configured to terminate the drying cycle, wherein the first idler arm is configured to depress the belt switch in the event of the belt breaks.

10. The dryer of claim 1, further comprising at least one S-baffle configured to enhance movement of items tumbling within the drum.

11. The dryer of claim 1, further comprising at least one baffle configured to promote movement of an item within the drum in an generally axial direction as the drum rotates.

12. The dryer of claim 1, further comprising a moisture sensor located substantially within the drying compartment, wherein the controller is further configured to:
receive an input from the moisture sensor, the input indicating a moisture level within the drum; and
substantially prevent the drying cycle from terminating when the input indicates the moisture level within the drum is greater than a maximum moisture level.

13. A method for improving drying efficiency within a dryer, the dryer comprising a controller and a drum configured to rotate in a first rotation direction, the drum including a baffle, the method comprising:
Rotating the drum in the first rotation direction; and
imparting movement to the tumbling contents of the dryer in a first axial direction during drum rotation,
periodically reversing the rotation direction during the drying cycle, wherein reversing the rotation direction promotes axial movement of the contents within the drum in the opposite direction.

14. The method of claim 13, further comprising:
receiving, at the controller, a moisture indication indicating a moisture level within the drum;
reversing the rotation direction when the moisture level remains constant for a preset time interval.

15. The method of claim 13, further comprising:
receiving, at the controller, a moisture indication indicating a moisture level within the drum;
terminating the drying cycle when the moisture level is below a minimum moisture level.

16. The method of claim 13, further comprising:
receiving, at the controller, a moisture indication indicating a moisture level within the drum;
extending the drying cycle when the moisture level is above a maximum moisture level.

17. A dryer for improving drying efficiency comprising:
a drum having a drying compartment;
a motor operatively connected to the drum, via a belt, and configured to cause the drum to rotate in a rotation direction during a first drying cycle portion; and
a controller, operatively connected to the motor, for controlling the dryer and configured to reverse the rotation direction during a second drying cycle portion.

18. The dryer of claim 17, further comprising:
an idler arm including an idler pulley configured to maintain a preset tension on the belt during the drying cycle;
a belt switch configured to terminate the drying cycle when depressed by the idler arm; and
a spring connected to the idler arm and configured to cause the idler arm to depress the belt switch when the belt breaks.

19. The dryer of claim 17, further comprising a moisture sensor located substantially within the drying compartment, wherein the controller is further configured to:
receive an input from the moisture sensor, the input indicating a moisture level within the drum; and
reverse the rotation direction during the drying cycle when the input indicates a constant moisture level for a preset time period.

20. The dryer of claim 17, further comprising:
a plurality of baffles projecting radially inward from the drum wall;
at least one of the baffles being configured to promote axial movement of an item within the drying compartment,

21. The dryer of claim 20 wherein the wherein the one baffle is of a generally S shaped configuration, and protrudes toward the center of drum a greater distance than the other baffles.

22. The dryer of claim 17, wherein the controller is configured to periodically reverse the rotation direction according to at least one preset drying cycle.

23. The dryer of claim 17, further comprising:
a plurality of baffles projecting radially inward from the drum wall;
at least one of the baffles being of generally S-shaped configuration toe enhance tumbling of items in the drum.

24. The dryer of claim 22 wherein the wherein the S-shaped baffle protrudes toward the center of drum a greater distance than the other baffles.
